(19) United States
(12) Patent Application Publication
(10) Pub. No.: US 2026/0050795 A1
(43) Pub. Date: Feb. 19, 2026

(54) VISUAL RETRIEVAL AUGMENTED GENERATION FOR MULTIMODAL LARGE LANGUAGE MODELS

(71) Applicant: NEC Laboratories America, Inc., Princeton, NJ (US)

(72) Inventors: Christopher Malon, Fort Lee, NJ (US); Renqiang Min, Princeton, NJ (US); Yun-Wei Chu, Austin, TX (US)

(21) Appl. No.: 19/302,244

(22) Filed: Aug. 18, 2025

Related U.S. Application Data
(60) Provisional application No. 63/684,508, filed on Aug. 19, 2024.
(60) Provisional application No. 63/754,206, filed on Feb. 5, 2025.

(51) Int. Cl. G06N 3/096

(52) U.S. Cl. CPC G06N 3/096

(57) ABSTRACT

Systems and methods for visual retrieval augmented generation for artificial intelligence models such as multimodal large language models. Associations between image and description pairs can be identified from an awareness dataset by finetuning a multi-modal large language model (MLLM) with the awareness dataset based on randomly chosen images added to each example from a relevant dataset. Visual distractions for image processing with the MLLM can be minimized by finetuning the MLLM with a focus dataset based on randomly chosen images added to each example from the relevant dataset. Visual hallucinations from the MLLM can be mitigated by finetuning the MLLM with a learning dataset based on related images having corresponding texts added to each example from the relevant dataset to utilize extracted information from associations between provided text from multiple images and a learning dataset.

### RELATED APPLICATION INFORMATION

This application claims priority to U.S. Provisional App. No. 63/684,508, filed on Aug. 19, 2024; and to U.S. Provisional App. No. 63/754,206, filed on Feb. 5, 2025; incorporated herein by reference in their entirety.

### BACKGROUND

### Technical Field

The present invention relates to training generative artificial intelligence (AI) models, and more particularly to visual retrieval augmented generation for multimodal large language models.

### Description of the Related Art

AI models have progressed over the years where they can generate human-like inferences for information obtained from texts and images. However, the inferences are dependent on the quality of the domain knowledge and maturity of the AI models. Less mature AI models tend to have limited domain knowledge, which leads to inaccurate inferences.

### SUMMARY

According to an aspect of the present invention, a method is provided, including, identifying associations between image and description pairs from an awareness dataset by finetuning a multi-modal large language model (MLLM) with the awareness dataset based on randomly chosen images added to each example from a relevant dataset, minimizing visual distractions for image processing with the MLLM by finetuning the MLLM with a focus dataset based on randomly chosen images added to each example from the relevant dataset, and mitigating visual hallucinations from the MLLM by finetuning the MLLM with a learning dataset based on related images having corresponding texts added to each example from the relevant dataset to utilize extracted information from associations between provided text from multiple images and a learning dataset.

According to another aspect of the present invention, a system is provided, including a memory device, one or more processor devices operatively coupled with the memory device to perform operations including, identifying associations between image and description pairs from an awareness dataset by finetuning a multi-modal large language model (MLLM) with the awareness dataset based on randomly chosen images added to each example from a relevant dataset, minimizing visual distractions for image processing with the MLLM by finetuning the MLLM with a focus dataset based on randomly chosen images added to each example from the relevant dataset, and mitigating visual hallucinations from the MLLM by finetuning the MLLM with a learning dataset based on related images having corresponding texts added to each example from the relevant dataset to utilize extracted information from associations between provided text from multiple images and a learning dataset.

According to yet another aspect of the present invention, a non-transitory computer program product is provided including a computer-readable storage medium including a program code, wherein the program code when executed on a computer causes the computer to perform, identifying associations between image and description pairs from an awareness dataset by finetuning a multi-modal large language model (MLLM) with the awareness dataset based on randomly chosen images added to each example from a relevant dataset, minimizing visual distractions for image processing with the MLLM by finetuning the MLLM with a focus dataset based on randomly chosen images added to each example from the relevant dataset, and mitigating visual hallucinations from the MLLM by finetuning the MLLM with a learning dataset based on related images having corresponding texts added to each example from the relevant dataset to utilize extracted information from associations between provided text from multiple images and a learning dataset.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing a system for visual retrieval augmented generation for multimodal large language models, in accordance with one embodiment of the present invention;

FIG. 2 is a block diagram showing a computer system for visual retrieval augmented generation for multimodal large language models, in accordance with an embodiment of the present invention;

FIG. 3 is a block diagram showing hardware and software components of a computer system for visual retrieval augmented generation for multimodal large language models, in accordance with an embodiment of the present invention;

FIG. 4 is a flow diagram showing a method for visual retrieval augmented generation for multimodal large language models, in accordance with an embodiment of the present invention;

FIG. 5 is a flow diagram showing more details of generating a learning dataset from an input dataset, in accordance with an embodiment of the present invention;

FIG. 6 is a flow diagram showing more details of finetuning of the multi-modal large language model to identify associations between image and description pairs from the awareness dataset, in accordance with an embodiment of the present invention;

FIG. 7 is a flow diagram showing more details of finetuning of the multi-modal large language model to generate text based on images from the focus dataset, in accordance with an embodiment of the present invention; and

FIG. 8 is a flow diagram showing more details of finetuning of the multi-modal large language model to learn from extracted information from associations between the provided text and images from the learning dataset, in accordance with an embodiment of the present invention.

### DETAILED DESCRIPTION OF PREFERRED EMBODIMENTS

In accordance with embodiments of the present invention, systems and methods are provided for visual retrieval augmented generation for multimodal large language models.

In the present embodiments, associations between image and description pairs can be identified from an awareness dataset by finetuning a multi-modal large language model (MLLM) with the awareness dataset based on randomly chosen images added to each example from a relevant dataset. Visual distractions for image processing with the MLLM can be minimized by finetuning the MLLM with a focus dataset based on randomly chosen images added to each example from the relevant dataset. Visual hallucinations from the MLLM can be mitigated by finetuning the MLLM with a learning dataset based on related images having corresponding texts added to each example from the relevant dataset to utilize extracted information from associations between provided text from multiple images and a learning dataset.

Recent advances in Multimodal Large Language Models (MLLMs) have demonstrated impressive capabilities in complex vision-and-text tasks, showing significant potential in specialized domains. In healthcare, the development of Medical MLLMs (MedMLLMs) can support clinical decision-making processes, with the potential to enhance physician efficiency and improve patient health outcomes. However, numerous studies have demonstrated that MLLMs are prone to hallucinations.

The hallucination tendency of MLLM's has been demonstrated on Med-MLLM's as well. This is particularly concerning in the healthcare scenario where even a few wrong tokens in text can lead to significant misinterpretations, affecting medical diagnoses, treatment plans, and patient outcomes. Retrieval-Augmented Generation (RAG) has become a prominent approach to mitigate the hallucination problem in Large Language Models (LLMs) by grounding text generation in retrieved knowledge relevant to a given query. Besides grounding, RAG potentially supplements the knowledge in a model's parameters with knowledge present in a corpus, enabling open book question answering to exceed closed book performance. Several prior works have explored text-based RAG in MLLMs. This approach assumes that using text documents associated with images similar to the query image can effectively augment the model, treating the retrieved images as interchangeable with the query image. However, this assumption is not always accurate.

Visual-RAG (VRAG) considers the associated text from retrieved similar images and the similar images themselves to provide more accurate responses to the given instruction. By incorporating both modalities, VRAG allows the model to determine what is important from the retrieved content, enhancing its ability to deliver more contextually relevant answers. With certain multi-image-trained Med-MLLMs, VRAG improves a detailed understanding of an image beyond what is possible with text-based RAG techniques.

The present embodiments can finetune MLLMs to improve the multimodal understanding and capabilities of MLLMs when presented with rich retrievals in VRAG. The present embodiments strengthen image-text comprehension and enable effective learning from similar resources retrieved during multimodal queries. They benefit not only MedMLLMs trained on multi-image dataset but also single image-trained models that can leverage multi-image inputs in VRAG, thereby improving performance. This enables model adaptability, allowing VRAG to be applied to any model and dataset of interest.

Embodiments described herein may be entirely hardware, entirely software or including both hardware and software elements. In a preferred embodiment, the present invention is implemented in software, which includes but is not limited to firmware, resident software, microcode, etc.

Embodiments may include a non-transitory computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

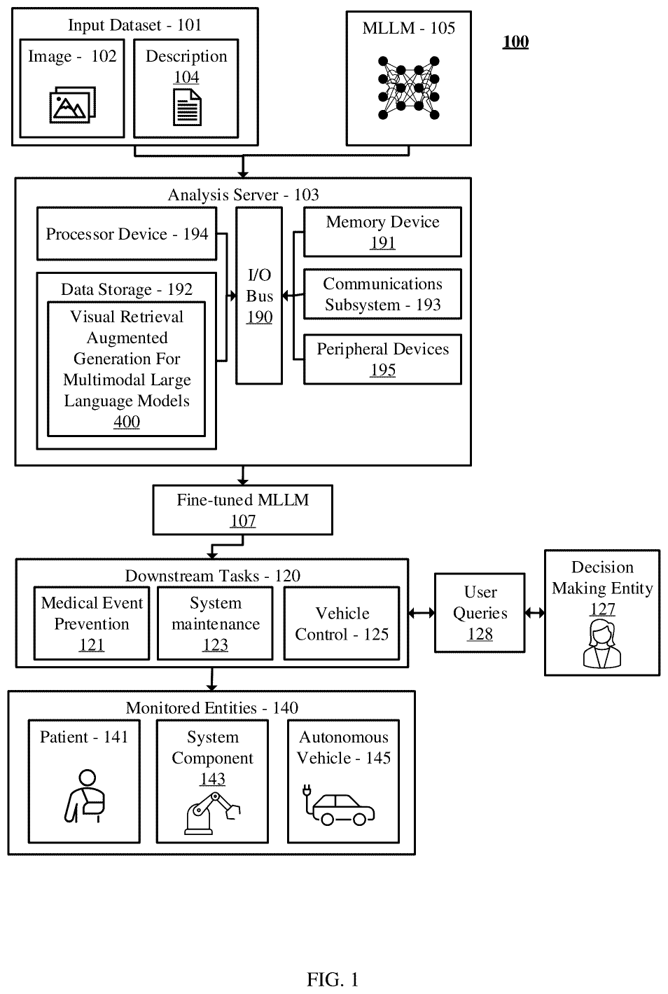

Referring now in detail to the figures in which like numerals represent the same or similar elements and initially to FIG. 1, a block diagram showing a system for visual retrieval augmented generation for multimodal large language models, in accordance with one embodiment of the present invention.

In system 100, monitored entities 140 can include patient 141, system component 143, and autonomous vehicle 145. The monitored entities 140 can generate an input dataset 101. The input dataset 101 can include image 102 and text description 104. The input dataset 101 can be transmitted to an analytic server 103 that can implement visual retrieval augmented generation for multimodal large language models 400. The analytic server 103 can communicate with a multi-modal large language model (MLLM) 105.

System 100 can be utilized to perform downstream tasks 120 based on the input dataset 101 and user queries 128 from a decision-making entity 127. The downstream tasks 120 can include medical event prevention 121, system maintenance 123, and vehicle control 125. The analytic server 103 can generate a corrective action for the downstream tasks 120 to be sent to respective computing systems for the monitored entities 140 through a network.

In medical event prevention 121, an input dataset 101 (e.g., x-ray images, vital sign readings, body scans, etc.) of a patient 141 can be processed to answer user queries 128. This process can include entity probing. Entity probing presents an image 102 to the fine-tuned MLLM 107 and asks yes/no questions about disease entities, and compares predictions against answers grounded in an LLM's interpretation of a reference report or caption. Entity probing provides a clinical perspective on text generations across medical domains which is not captured by natural language generation metrics such as ROUGE, while avoiding sensitivity to entity phrasing. VRAG, when applied as an inference technique to Med-MLLMs trained on multi-image datasets, enhances understanding more effectively than original Med-MLLMs and previous text-based RAG systems.

Based on the predictions of the fine-tuned MLLM 107, a corrective action can be generated by the fine-tuned MLLM 107 through autonomous decision making. The corrective action can include notifying the decision making entity 127 of the medical predictions (e.g., existence of disease, changes in vital signs, recommendations to mitigate disease, etc.) about the patient 141 based on their input dataset 101, generating a medical summary of the input dataset 101 to help with the decision making process of the decision making entity 127, etc.

In system maintenance 123, input dataset 101 (e.g., system logs, test cases, hardware status images, etc.) related to the system component 143 can be processed to answer user queries 128. The user queries 128 can be relevant on how to properly maintain the system component 143 based on the input dataset 101. A corrective action can be generated by the analytic server 103 which can include the answer to the user queries 128 (e.g., determine causes to bandwidth issues, etc.) to maintain the system component 143 based on determined issues with the system component 143. Based on the corrective action (e.g., adding bandwidth, blocking packets from an identified internet protocol (IP) address to resolve malicious attacks, restarting hardware, etc.) the network system can be autonomously maintained through autonomous decision making.

In vehicle control 125, input dataset 101 (e.g., vehicle part status, traffic scene image, etc.) related to the autonomous vehicle 145 can be processed to answer user queries 128. The user queries 128 can be relevant to how to control the autonomous vehicle 145 given its environment based on the input dataset 101. A corrective action can be generated by the analytic server 103 which can include the answer to the user queries 128 to control the proper performance of the autonomous vehicle 145 through autonomous decision making. Based on the corrective action (e.g., stopping, speeding up, changing direction, etc.) the autonomous vehicle 145 can be autonomously controlled using appropriate control devices (e.g., advanced driver assistance systems, braking device, accelerator device, cooling device, etc.) within the autonomous vehicle.

Other downstream tasks and practical applications are contemplated.

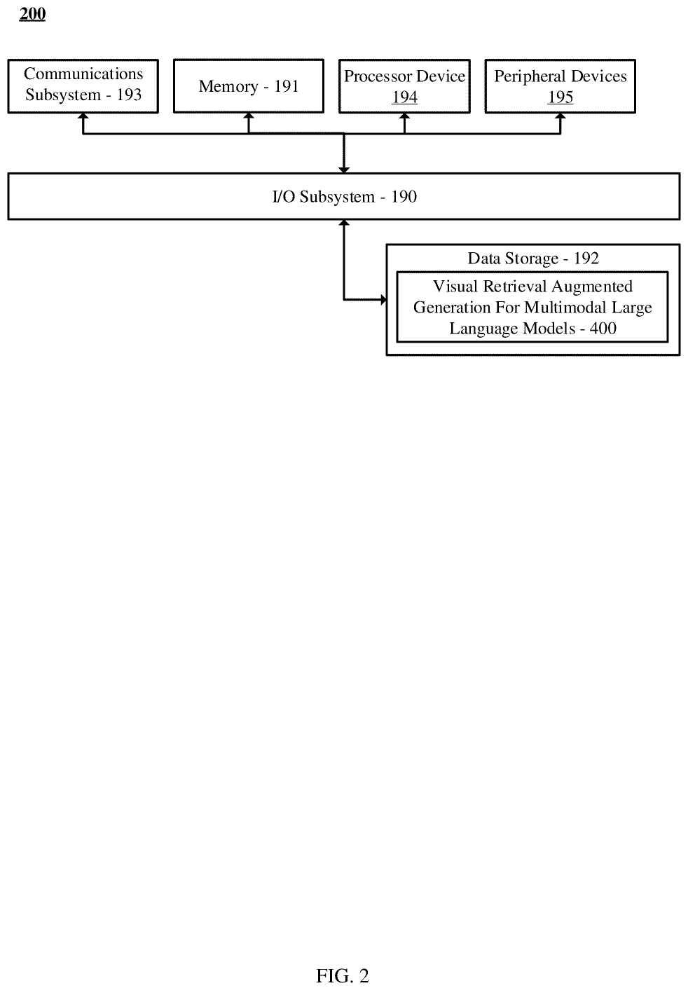

The analytic server 103 can include a processor device 194, data storage 192, memory device 191, communications subsystem 193, peripheral devices 195, and input/output (I/O) bus 190. The analytic server 103 is an implementation of a computer system. Other implementations are contemplated. The computer system is shown in more detail in FIG. 2.

Referring now to FIG. 2, a block diagram showing a computer system for visual retrieval augmented generation for multimodal large language models, in accordance with an embodiment of the present invention.

The computing device 200 illustratively includes the processor device 194, an input/output (I/O) subsystem 190, a memory 191, a data storage device 192, and a communication subsystem 193, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 191, or portions thereof, may be incorporated in the processor device 194 in some embodiments.

The processor device 194 may be embodied as any type of processor capable of performing the functions described herein. The processor device 194 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 191 may be embodied as any type of volatile or non-volatile memory or data storage capable of performing the functions described herein. In operation, the memory 191 may store various data and software employed during operation of the computing device 200, such as operating systems, applications, programs, libraries, and drivers. The memory 191 is communicatively coupled to the processor device 194 via the I/O subsystem 190, which may be embodied as circuitry and/or components to facilitate input/output operations with the processor device 194, the memory 191, and other components of the computing device 200. For example, the I/O subsystem 190 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 190 may form a portion of a system-on-a-chip (SOC) and be incorporated, along with the processor device 194, the memory 191, and other components of the computing device 200, on a single integrated circuit chip.

The data storage device 192 may be embodied as any type of device or devices configured for short-term or long-term storage of data such as, for example, memory devices and circuits, memory cards, hard disk drives, solid state drives, or other data storage devices. The data storage device 192 can store program code for visual retrieval augmented generation for multimodal large language models 400. Any or all of these program code blocks may be included in a given computing system.

The communication subsystem 193 of the computing device 200 may be embodied as any network interface controller or other communication circuit, device, or collection thereof, capable of enabling communications between the computing device 200 and other remote devices over a network. The communication subsystem 193 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 195. The peripheral devices 195 may include any number of additional input/output devices, interface devices, and/or other peripheral devices. For example, in some embodiments, the peripheral devices 195 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

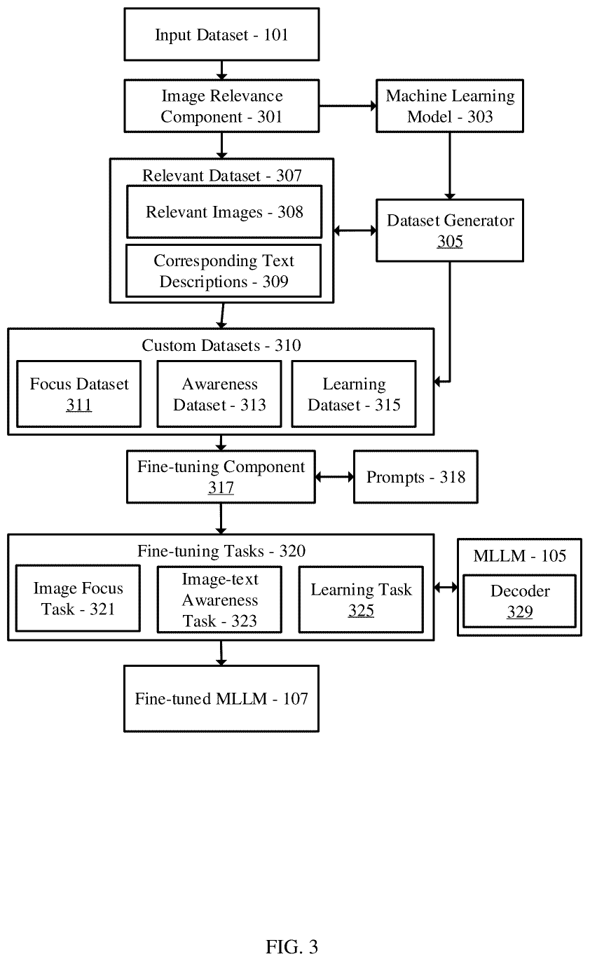

Referring now to FIG. 3, a block diagram showing hardware and software components of a computer system for visual retrieval augmented generation for multimodal large language models, in accordance with an embodiment of the present invention.

System 200 can utilize hardware and software components to generate a fine-tuned MLLM 107. The hardware and software components include an image relevance component 301, a machine learning model 303, a dataset generator 305, and a fine-tuning component 317.

The image relevance component 301 can determine relevant images 308 and corresponding text descriptions 309 based on the input dataset 101 by utilizing machine learning model 303. The dataset generator 305 can generate a relevant dataset 307 from the relevant images 308 and corresponding text descriptions 309.

Based on the relevant dataset 307, custom datasets 310 can be generated by the dataset generator 305. The custom datasets 310 include a focus dataset 311, an awareness dataset 313, and a learning dataset 315.

The fine-tuning component 317 can fine-tune the MLLM 105 with fine-tuning tasks 320 to obtain fine-tuned MLLM 330. The fine-tuning tasks 320 include an image focus task 321, an image-text awareness task 323, and a learning task 325.

The MLLM 105 is a multi-modal large language model that can support text and image input. The MLLM 105 can be extended to support multiple images by defining distinct offset vectors that are added to the image embeddings to represent the image number within the input sequence.

The MLLM 105 includes a machine learning model 303, which can utilize an image encoder, to create a relevant dataset 307 which can serve as an index of relevant images 308 and corresponding text descriptions 309 in the input dataset 101. To answer a query consisting of a visual query image and query text, one or more relevant images 308 and their corresponding text descriptions 309 are retrieved from the index to generate the custom datasets 310. Prompts 318 are constructed which concatenate the retrieved images and their corresponding texts with the query image and query text, following a template. The MLLM 105 responds to the visual query image and query text by generating text with its decoder 329 following the prompt.

The use of retrieved images in addition to retrieved text enables the MLLM 105 to better judge what aspects of the retrieved text are relevant to the query. The awareness dataset 313 and the focus dataset 311 enhance the capability of the model to distinguish multiple images, particularly helping in cases where not all the retrieved images are relevant to the query image. Different image offset vectors per image can prevent the model from mixing up features of different images. By utilizing previous images and texts, the model can incorporate knowledge about rare visual phenomena for which there was little training data.

The machine learning model 303 can utilize neural networks.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The neural network, such as a multilayer perceptron, can have an input layer of source neurons, one or more computation layer(s) having one or more computation neurons, and an output layer, where there is a single output neuron for each possible category into which the input example could be classified. An input layer can have a number of source neurons equal to the number of data values in the input data. The computation neurons in the computation layer(s) can also be referred to as hidden layers, because they are between the source neurons and output neuron(s) and are not directly observed. Each neuron in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons in the one or more computation (hidden) layer(s) perform a nonlinear transformation on the input data that generates a feature space. The classes or categories may be more easily separated in the feature space than in the original data space.

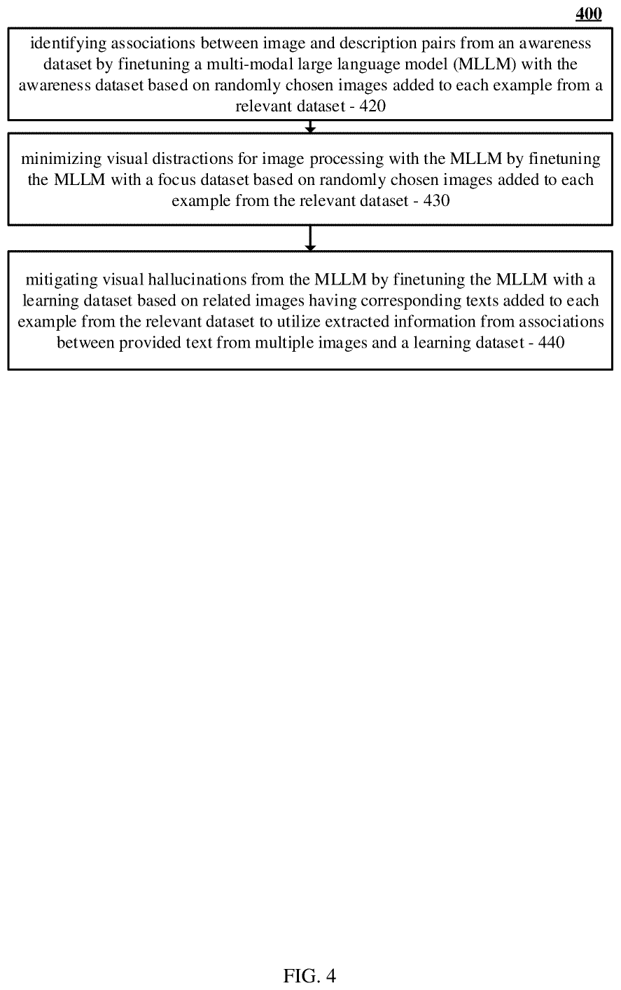

Referring now to FIG. 4, a flow diagram showing a method for visual retrieval augmented generation for multimodal large language models, in accordance with an embodiment of the present invention.

In an embodiment, associations between image and description pairs can be identified from an awareness dataset by finetuning a multi-modal large language model (MLLM) with the awareness dataset based on randomly chosen images added to each example from a relevant dataset. Visual distractions for image processing with the MLLM can be minimized by finetuning the MLLM with a focus dataset based on randomly chosen images added to each example from the relevant dataset. Visual hallucinations from the MLLM can be mitigated by finetuning the MLLM with a learning dataset based on related images having corresponding texts added to each example from the relevant dataset to utilize extracted information from associations between provided text from multiple images and a learning dataset. Other fine-tuning tasks can be utilized and combined with the tasks described herein.

In block 410, a learning dataset that includes relevant images and text description pairs can be generated from an input dataset determined with a machine learning model.

MLLMs may lack learned knowledge to distinguish information from multiple images. To address this, fine-tuning tasks 320 can be performed to enhance image-text association in the VRAG process. Given an input dataset 101 of images paired with text descriptions or reports, the relevant dataset 307 can be defined as

$$S = ( i m {g}_{i} , {P}_{i} , {A}_{i} ) {\vert}_{i = 1}^{N} ,$$

where imgᵢ denotes the i-th relevant image 308, Pᵢ and Aᵢ represent the prompt 318 and the answer, respectively, and N is the total number of samples.

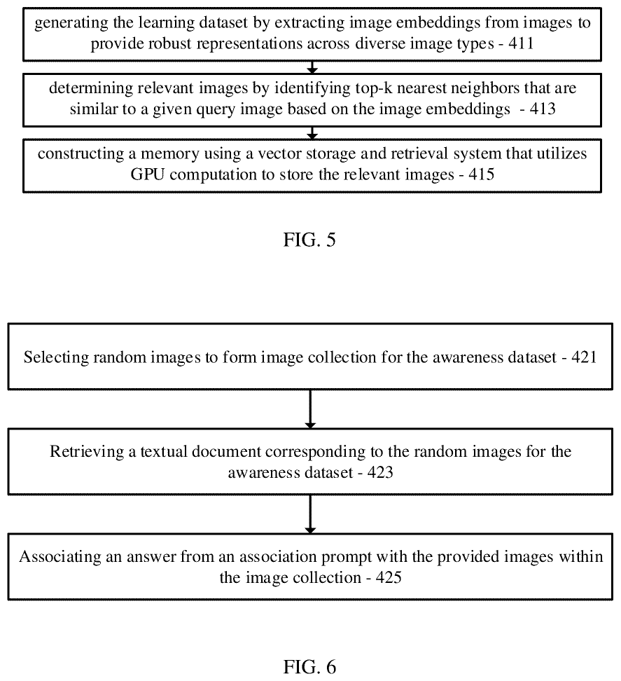

Datasets can be generated from images and corresponding textual descriptions that match the features of target medical images. These datasets, rich in visual and textual medical details, guide response generation for the medical image through fine-tuning. This is shown in more detail in FIG. 5.

Referring now to FIG. 5, a flow diagram showing more details of generating a learning dataset from an input dataset, in accordance with an embodiment of the present invention.

In block 411, a machine learning model, such as an image encoder (e.g., Biomed contrastive language-image pre-training (CLIP)), can be employed to extract image embeddings to provides robust representations across diverse image types. For a given image X_{img}, an image embedding E_{img}∈ [symbol] ^{d} can be extracted with d representing the dimension (i.e., 512 for BiomedCLIP). The image embedding can be stored in memory M for retrieval later.

In block 413, an approximate kNN search can be employed using the Hierarchical Navigable Small World (HNSW) algorithm to identify the top-k nearest neighbors which can retrieve the images in M most similar to a given query image.

In block 415, to facilitate efficient search operations during the inference phase, the memory M can be constructed using Facebook™ AI Similarity Search (FAISS), a vector storage and retrieval system that utilizes GPU computation. Other nearest neighbor search method can be utilized.

In block 420, associations between image and description pairs can be identified from an awareness dataset by finetuning a multi-modal large language model (MLLM) with the awareness dataset based on randomly chosen images added to each example from a relevant dataset.

The image-and-text association ability of the MLLM can be enhanced by training the model to identify the relevant image corresponding to provided text from multiple images. To achieve this, the awareness dataset, a multi-image dataset, Mₚₒₛ, can be constructed from relevant dataset 307 S. This is shown in FIG. 6.

Referring now to FIG. 6, a flow diagram showing more details of finetuning of the multi-modal large language model to identify associations between image and description pairs from the awareness dataset, in accordance with an embodiment of the present invention.

In block 421, random images can be selected from the relevant dataset to form an image collection for the awareness dataset. K images (e.g., K ranges from 1 to 5) can be randomly selected from the relevant dataset 307 to form the image collection (img_{i,1}, . . . , img_{i,K}).

In block 423, a textual document corresponding to the random images can be retrieved for the awareness dataset. An integer j from [1, K] can be chosen and a textual document R_{i,j} that corresponds to img_{i,j} can be retrieved.

In block 425, an answer from an association prompt can be associated with the provided images within the image collection for the awareness dataset. The awareness dataset can be compiled using

$$\{ ( {img}_{i , 1} , … , {img}_{i , K} , {P}_{i , j}^{′} , {A}_{i , j}^{′} ) \} \cdot {P}_{i , j}^{′}$$

is an association prompt which is a newly formulated prompt designed to ask a position-based question in addition to the original question P_{i,j}, associating A_{i,j} with the provided images. For example, the association prompt can include “What image from 1 to K does this A_{i,j} correspond to? P_{i,j}”.

$${A}_{i , j}^{′}$$

is the answer indicating ine position of img_{i,j} among the provided images, for example, “The j-th image.”

Referring now back to FIG. 4, in block 430, visual distractions for image processing with the MLLM can be minimized by finetuning the MLLM with a focus dataset based on randomly chosen images added to each example from the relevant dataset.

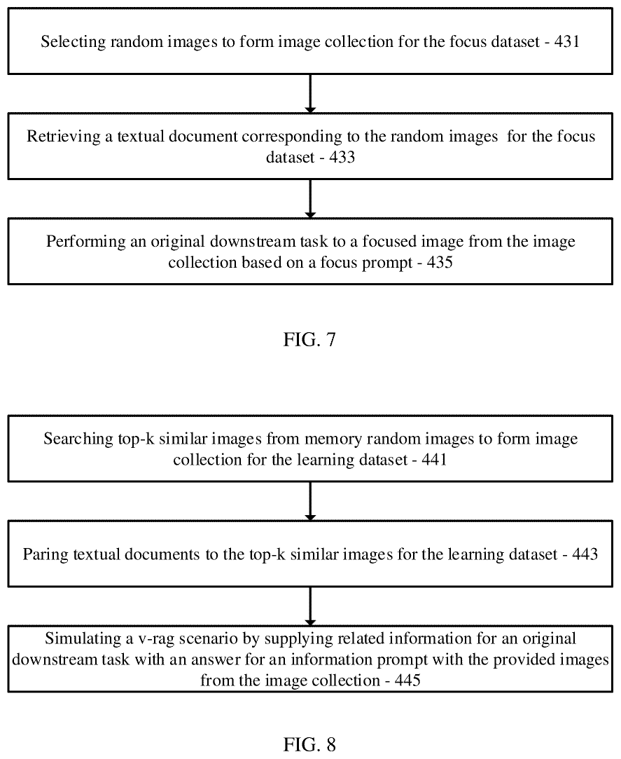

In this task, the MLLM 105 can be directed to focus on a specific image from a set of multiple images and subsequently perform text generation based on that image. By doing so, performance of the MLLM 105 can be improved by minimizing distractions from other visual inputs. To achieve this, a focus dataset (M_{focus}) can be created from image dataset S. This is shown in more detail in FIG. 7.

Referring now to FIG. 7, a flow diagram showing more details of finetuning of the multi-modal large language model to generate text based on images from the focus dataset, in accordance with an embodiment of the present invention.

In block 431, random images can be selected to form an image collection for the focus dataset. K images from S can be randomly selected S to form the image collection (img_{i,1}, . . . , img_{i,K}).

In block 433, a textual document corresponding to the random images can be retrieved for the focus dataset. An integer j from [1, K] can be chosen to select textual documents that correspond to the random images.

In block 435, a downstream task can be performed to a focused image from the image collection. An focus dataset can be generated

$$\{ ( i m {g}_{i , 1} , … , {img}_{i , K} , {P}_{i , j}^{″} , {A}_{i , j}^{″} ) \}$$

to form M_{focus}, where

$${P}_{i , j}^{″}$$

is a focus prompt which is a formulated prompt designed to help the model focus on a specified image, img_{i,j}, and pose the original question P_{i,j} for that image. For example, the new prompt

$${P}_{i , j}^{″}$$

is “Focus on the j-th image, P_{i,j}.”, where P_{i,j} is the original prompt that asks for a finding/report to be generated from a given image. After generating the focus dataset, the MMLM can be finetuned by asking the MLLM to identify the position of the image related to the given text using the awareness dataset.

In an embodiment, various conditions may be applied to the random selection of images for both image-text awareness and image-focus tasks. For example, when the image dataset S consists of images imgᵢ with radiology reports Aᵢ, the selected report A_{i,j} for the focus image can be filtered to contain at least one label that is distinct from those in the other reports

$$\{ {A}_{{i}_{m}} \} {\vert}_{m = 1 , m \neq j}^{K} .$$

This strategy simplifies the learning task by ensuring that there are no alternative images to which the report could apply equally well. For easier and more diverse datasets, such a strategy may not be necessary.

Referring now back to FIG. 4, in block 440, visual hallucinations from the MLLM can be mitigated by finetuning the MLLM with a learning dataset based on related images having corresponding texts added to each example from the relevant dataset to utilize extracted information from associations between provided text from multiple images and a learning dataset.

Extracted similar information during VRAG can be utilized to increase the learning capability of the MLLM in decision-making. To do so, the VRAG scenario can be simulated and a learning dataset, M_{vrag} can be generated. This is shown in more detail in FIG. 8.

Referring now to FIG. 8, a flow diagram showing more details of finetuning of the multi-modal large language model to learn from extracted information from associations between the provided text and images from the learning dataset, in accordance with an embodiment of the present invention.

In block 441, given a query image img_{q} in the validation set, the top-K similar images (img_{q,1}, . . . , img_{q,K}) can be searched from memory for the learning dataset.

In block 443, the top-K similar images can be paired with their corresponding textual documents (A_{q,1}, . . . , A_{q,K}) from memory for the learning dataset.

In block 445, a VRAG scenario can be simulated by supplying related information for a downstream task with an answer for an information prompt with provided images from the image collection.

The learning dataset can include

$$\{ ( i m {g}_{q , 1} , {A}_{q , 1} , … , {img}_{q , K} , {A}_{q , K} ) , i m {g}_{q} , {P}_{q}^{′′′} , {A}_{q} \}$$

where, A_{q} is the answer for query image img_{q}, and

$${P}_{q}^{′′′}$$

is a new prompt designed to supply related information alongside the original question P_{q}.

Taking disease entity probing as example,

$${P}_{q}^{′′′}$$

can be “Based on ine query image, and the similar images and their reports: (img_{q,1}, A_{q,1}, . . . , img_{q,K}, A_{q,K}),

$${P}_{q}^{′′′} ,$$

and P_{q} is “Does the patient have [disease entity]?”. Other downstream tasks can be performed such as summary generation.

In the inference stage, in an embodiment, a query image X_{q} can be encoded to obtain its corresponding image embedding. The top-k images in M can be retrieved and the retrieved set of similar images and their reports can be represented as (I₁, . . . , I_{K}) and (R₁, . . . , R_{K}), respectively. The retrieved images can guide the generation of fine-tuned MLLM 107 for the query image by appending each reference before the question, following this prompt guidance: “ . . . . This is the i-th similar image and its report for your reference. [Reference] i . . . . Answer the question with only the word yes or no. Do not provide explanations. According to the last query image and the reference images and reports, [Question][Query Image]”, where [References]i is structured as [(Iᵢ, Rᵢ)].

The present embodiments can finetune MLLMs to improve the multimodal understanding and capabilities of MLLMs when presented with rich retrievals in VRAG. The present embodiments strengthens image-text comprehension and enables effective learning from similar resources retrieved during multimodal queries. It benefits not only MedMLLMs trained on multi-image dataset but also single image-trained models that can leverage multi-image inputs in VRAG, thereby improving performance. This enables model adaptability, allowing VRAG to be applied to any model and dataset of interest. By performing the finetuning tasks, the present embodiments can mitigate visual hallucinations.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method, comprising:
identifying associations between image and description pairs from an awareness dataset by finetuning a multi-modal large language model (MLLM) with the awareness dataset based on randomly chosen images added to each example from a relevant dataset;
minimizing visual distractions for image processing with the MLLM by finetuning the MLLM with a focus dataset based on randomly chosen images added to each example from the relevant dataset; and
mitigating visual hallucinations from the MLLM by finetuning the MLLM with a learning dataset based on related images having corresponding texts added to each example from the relevant dataset to utilize extracted information from associations between provided text from multiple images and a learning dataset.

2. The method of claim 1, further comprising generating the learning dataset by extracting image embeddings from images to provide robust representations across diverse image types.

3. The method of claim 2, wherein generating the learning dataset further comprises identifying top-k nearest neighbors that are similar to a given query image based on the image embeddings.

4. The method of claim 1, wherein generating the learning dataset further comprises constructing a memory using a vector storage and retrieval system that utilizes graphics processing unit (GPU) computation to store images from the relevant dataset.

5. The method of claim 1, wherein identifying the associations further comprises associating an answer for an association prompt with provided images from an image collection for the awareness dataset.

6. The method of claim 1, wherein minimizing the visual distractions further comprises performing a downstream task to a randomly chosen and identified image from an image collection for the focus dataset.

7. The method of claim 1, wherein mitigating the visual hallucinations further comprises simulating a visual retrieval augmented generation by supplying related information for a downstream task with an answer for an information prompt with provided images from an image collection for the learning dataset.

8. The method of claim 1, further comprising notifying a decision-making entity of medical predictions generated by the MLLM for an existence of disease for a patient based on an input dataset through autonomous decision making.

9. A system, comprising:
a memory device;
one or more processor devices operatively coupled with the memory device to perform operations including:
identifying associations between image and description pairs from an awareness dataset by finetuning a multi-modal large language model (MLLM) with the awareness dataset based on randomly chosen images added to each example from a relevant dataset;
minimizing visual distractions for image processing with the MLLM by finetuning the MLLM with a focus dataset based on randomly chosen images added to each example from the relevant dataset; and
mitigating visual hallucinations from the MLLM by finetuning the MLLM with a learning dataset based on related images having corresponding texts added to each example from the relevant dataset to utilize extracted information from associations between provided text from multiple images and a learning dataset.

10. The system of claim 9, further comprising generating the learning dataset by extracting image embeddings from images to provide robust representations across diverse image types.

11. The system of claim 10, wherein generating the learning dataset further comprises identifying top-k nearest neighbors that are similar to a given query image based on the image embeddings.

12. The system of claim 9, wherein generating the learning dataset further comprises constructing a memory using a vector storage and retrieval system that utilizes graphics processing unit (GPU) computation to store images from the relevant dataset.

13. The system of claim 9, wherein identifying the associations further comprises associating an answer for an association prompt with provided images from an image collection for the awareness dataset.

14. The system of claim 9, wherein minimizing the visual distractions further comprises performing a probing downstream task to a focused image from an image collection for the focus dataset.

15. The system of claim 9, wherein mitigating the visual hallucinations further comprises simulating a visual retrieval augmented generation by supplying related information for a downstream task with an answer for an information prompt with provided images from an image collection for the learning dataset.

16. The system of claim 9, further comprising notifying a decision-making entity of medical predictions generated by the MLLM for an existence of disease for a patient based on an input dataset through autonomous decision making.

17. A non-transitory computer program product comprising a computer-readable storage medium including a program code, wherein the program code when executed on a computer causes the computer to perform:
identifying associations between image and description pairs from an awareness dataset by finetuning a multi-modal large language model (MLLM) with the awareness dataset based on randomly chosen images added to each example from a relevant dataset;
minimizing visual distractions for image processing with the MLLM by finetuning the MLLM with a focus dataset based on randomly chosen images added to each example from the relevant dataset; and
mitigating visual hallucinations from the MLLM by finetuning the MLLM with a learning dataset based on related images having corresponding texts added to each example from the relevant dataset to utilize extracted information from associations between provided text from multiple images and a learning dataset.

18. The non-transitory computer program product of claim 17, further comprising generating the learning dataset by extracting image embeddings from images to provide robust representations across diverse image types.

19. The non-transitory computer program product of claim 18, wherein generating the learning dataset further comprises identifying top-k nearest neighbors that are similar to a given query image based on the image embeddings.

20. The non-transitory computer program product of claim 17. further comprising notifying a decision-making entity of medical predictions generated by the MLLM for an existence of disease for a patient based on an input dataset through autonomous decision making.
